(19) United States
(12) Patent Application Publication
(10) Pub. No.: US 2015/0075331 A1
(43) Pub. Date: Mar. 19, 2015

(54) Easy bolt extractor

(71) Applicant: Thomas Catalano, Gillette, WY (US)

(72) Inventor: Thomas Catalano, Gillette, WY (US)

(21) Appl. No.: 13/987,951

(22) Filed: Sep. 17, 2013

(51) Int. Cl. B25B 27/18

(52) U.S. Cl. CPC B25B 27/18
USPC 81/53.2

(57) ABSTRACT

An easy bolt extractor is disclosed which may be used to remove a broken bolt shaft or similar article from a hole and which is operated using a socket driver.

### BACKGROUND OF THE INVENTION

1. Field of the Invention

The present invention relates generally to tools and more specifically to an easy bolt extractor which may be used to remove a broken off bolt or screw.

2. Background Information

For hundreds of years people have been using a variety of bolts and screws. Inevitably, some of these bolts (references to bolts below are also considered to reference bolts, screws, and similar fasteners) break off leaving a portion of the bolt stuck within a hole. Several extractors have been developed which are intended to be used to remove the broken off bolt from the hole in which it is stuck. Extractors intended to be used for worn or damages bolt heads are not considered here.

Generally speaking, conventional extractors are all used in about the same way. A bolt might break off, for example, in an engine block. To remove the bolt shaft, a hole must be drilled into the center of the shaft and aligned with the longitudinal axis of the shaft. An appropriately sized extractor is selected and the square end of the extractor is fastened into the chuck of a reversible drill. The drill is used to screw the extractor into the hold in the bolt. After the extractor has been screwed into the bolt shaft, the drill continues to turn in the reverse direction and, theoretically, the broken shaft will be turned and screwed out from the hole.

On many occasions a conventional wrench, such as a combination wrench, is used to operate a conventional extractor in instances where the drill doesn't work properly. That is, a wrench may be used on the square end of the extractor rather than the drill. A number of articles other than bolts such as a helicoil insert.

Bolt extractors have been in use for many years and they work well in many circumstances. However, conventional extractors may not be used in a variety of situations. For example, a bolt might break off in a hole in a position in which it is too deep to be reached by a conventional extractor. Because of its relatively large diameter, the chuck of a drill won't fit in most commonly used hole sizes, which limits the use of the extractor. For obvious reasons, if a drill won't work in a particular situation, there won't be enough room for a wrench to work either. In addition, conventional extractors just are too short to be used in a number of situations.

The easy bolt extractor of the instant invention solves the above problems by providing a device which may be used to extract a broken bolt in situations in which a conventional extractor will not work. The instant invention is also capable of being operated using a standard wrench or socket wrench. The device is also simple, light weight, reliable, inexpensive, and easy to operate and maintain.

### SUMMARY OF THE INVENTION

The easy bolt extractor of the instant invention is similar to a conventional extractor in that it includes a tip the same as a conventional extractor tip. However, rather than having a squared off end created for use with a drill and chick, the easy bolt extractor of the instant invention has a female sock end affixed to the end of the extractor opposite the tip. While a conventional bolt extractor is typically operated using an electric drill, the easy bolt extractor of the instant invention is operated by using a conventional socket driver or wrench.

One of the major objects of the present invention is to provide a device which may be used to extract a broken bolt or similar object in situations in which a conventional extractor will not work.

Another objective of the present invention is to provide an extractor which is capable of being operated using a standard wrench or socket driver.

Another objective of the present invention is to provide an easy bolt extractor which is simple, light weight, reliable, inexpensive, and easy to operate and maintain.

These and other features of the invention will become apparent when taken in consideration with the following detailed description and the drawings.

### BRIEF DESCRIPTION OF THE DRAWINGS

FIG. 1 is a side view of a conventional or standard bolt extractor; and

FIG. 2 is a side view of easy bolt extractor of the instant invention.

### DESCRIPTION OF A PREFERRED EMBODIMENT

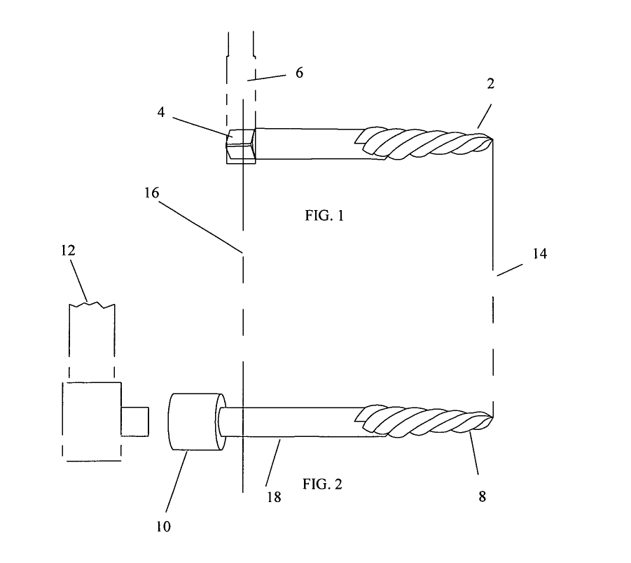

Referring to the drawings, FIGS. 1 and 2 there is shown a preferred embodiment of the instant invention. For purposes of this application, the working end of an extractor is considered the tip and the other end is considered the connector.

Now referring to FIG. 1, a side view of a conventional or standard bolt extractor is shown. Bolt extractors have been manufactured and used for a number of years and appear to be made and marketed using a number of standard sizes. A conventional bolt extractor includes a tip 2 at one end and a connector 4 which may be used to connect the extractor to the chuck of an electric drill. A conventional wrench 6 may also be used to engage the connector of a conventional bolt extractor. The wrench 6 is not considered part of the invention and is shown using phantom lines. The connector 4 is square and configured to fit in the chuck of an electric drill.

Still referring to FIG. 1, in a typical operation the head of a bolt breaks off leaving the bolt shaft stuck in the bolt hole. To remove the bolt shaft, a hole is drilled down into the center of the bolt shaft. An appropriately sized bolt extractor is selected and fitted into the chuck of an electric drill. Using the drill, the extractor is screwed down into the hole in the bolt shaft until the extractor becomes removably affixed to the bolt shaft. Once the extractor is affixed to the bolt shaft, the drill is reversed and, theoretically, the bolt shaft is unscrewed from the hole and removed.

Referring now to FIG. 2, a side view of the instant invention is shown. The easy bolt extractor of the instant invention includes an easy tip 8 at one end which is the same as said tip 2 on the conventional bolt extractor. Rather than said square connector 4 found on the conventional bolt extractor, the easy bolt extractor includes a female socket connector 10. Rather than being typically operated by using an electric drill, the easy bolt extractor is typically operated using a conventional socket driver 12. Thus, the instant invention includes a socket connector 10 connected to a shaft 18 and an easy tip 8 on the opposite end of that shaft 18 from said socket connector 10. The socket driver 12 is not considered part of the invention and is shown using phantom lines. The instant invention operates in the same manner as described above, but a socket driver rather than an electric drill is used.

In the following, reference is made to both FIG. 1 and FIG. 2. Line 14 shows that in these figures, the tips of the two extractors are aligned. That is, the two extractors are shown in the positions they would be in if either were used to extract the same broken off bolt shaft. Line 16 represents the depth of the hole in which the bolt shaft is located. As may be seen, in this situation the conventional bolt extractor will not work. Neither an electric drill nor a wrench 6 may be fitted onto the connector 4 end of the conventional bolt extractor. The easy bolt extractor of the instant invention will work to remove a broken bolt shaft in this situation. Said socket driver 12 may still be affixed to said socket connector 10 in situations where neither an electric drill nor conventional wrench may be connected to said connector 4 on the conventional bolt extractor. If necessary, a conventional socket driver extension (not shown) may be used to connect said socket driver 12 to said socket connector 10.

Thus, as may be seen, the easy bolt extractor of the instant invention may be used to extract a broken bolt shaft or similar article from a hole in situations where a conventional bolt extractor will not.

In the preferred embodiment all elements are conventional with structural elements being made from steel although other materials having similar properties could be used.

I claim:

1. An easy bolt extractor which may be used for the same purpose as a conventional bolt extractor and which has a tip at one end and a connector at the other, comprising:
(1) a tip which is the same as the tip of a conventional bolt extractor;
(2) a shaft affixed to said tip; and
(3) a connector which is configured the same as a conventional female socket connector and is affixed to the shaft and the end opposite said tip.
